(19) United States
(12) Patent Application Publication
(10) Pub. No.: US 2016/0316379 A1
(43) Pub. Date: Oct. 27, 2016

(54) SYSTEMS AND METHODS FOR CONTROLLING THE DATA RATE OF AN INTERNET PROTOCOL COMMUNICATION

(71) Applicant: VONAGE NETWORK, LLC, Holmdel, NJ (US)

(72) Inventors: Deepak OTTUR, Hillsborough, NJ (US); Rohan DWARKHA, Mendham, NJ (US)

(21) Appl. No.: 14/795,111

(22) Filed: Jul. 9, 2015

Related U.S. Application Data
(60) Provisional application No. 62/151,028, filed on Apr. 22, 2015.

(51) Int. Cl. H04W 24/02; H04L 29/06; H04B 17/318

(52) U.S. Cl. CPC H04W 24/02; H04B 17/318; H04L 65/80

(57) ABSTRACT

Systems and methods of controlling the data rate used to conduct IP telephony communications may make use of historical data network conditions to predict the data rates which can be used for individual new IP telephony communications. Also, the data rates at which IP telephony communications are conducted may be restricted or lowered to avoid causing a user to exceed an allowable data usage budget. Further, when two IP telephony devices are setting up a new IP telephony communication, information about their respective data communication capabilities may be exchanged in setup messaging.

### BACKGROUND OF THE INVENTION

The invention is related to Internet Protocol (IP) telephony systems. More specifically, the invention is related to systems and methods for controlling the data rate used to conduct an IP telephony communication.

When an audio or video IP telephony communication is conducted between first and second parties, via data communications, an encoding/decoding scheme is used by the first party's telephony device to convert an audio or video signal received from or generated by the first party into a stream of data packets. Those data packets are sent to the second party's telephony device via a data network. The second party's telephony device uses a similar encoding/decoding scheme to convert the received data packets back into an audio or video signal, which is then used to play the audio or video to the second party. In a typical audio or video telephony communication, the same thing is simultaneously happening in reverse. In other words, the second party's telephony device encodes an audio or video signal received from or generated by the second party into data packets, and sends the data packets to the first party's telephony device. The first party's telephony device converts the received data packets back into an audio or video signal, and the audio or video signal is used to play audio or video to the first party.

The encoding and decoding schemes used to convert an audio or video signal into data packets, and to convert the data packets back into an audio or video signal, are commonly referred to as CODECs. Although a CODEC can be embodied in a physical electrical circuit structure, CODECs are typically computer algorithms or computer programs running on a processor.

Different CODECs can be used to convert the same audio or video stream into varying amounts of digital data. Thus, a first CODEC could convert an input audio/video signal into a first digital data stream having a first bit rate, while a second CODEC converts the same input audio/video stream into a second digital data stream having a second, lower bit rate. In addition, some CODECs are multi-rate, meaning they can generate output digital data are a plurality of different bit rates. In most cases, the higher the bit rate, the better the quality of the communication. Thus, in the absence of other constraining factors, it is desirable to use a CODEC that creates a digital data stream having the largest possible bit rate, as that is likely to result in the highest quality communication.

Unfortunately, there are several factors that constrain the bit rates that can be used for IP telephony communications. One factor is the bandwidth available for data communications passing between a first party's telephony device and a second party's telephony device. The CODEC that is used must be capable of generating a digital data stream with a low enough bit rate to send the digital data stream through all links that extend between the first and second party's telephony devices.

It is common for the link between one party's telephony device and the data network to have a smaller bandwidth than the link between the other party's telephony device and the data network. The link with the lowest bandwidth will determine the maximum data bit rate that can be used for a telephony communication. In some instances, a link within the data network itself may be the constraining factor that determines the maximum bit rate that can be used. In still other instances, one party's telephony device may be the constraining factor in determining the maximum bit rate that can be used.

In some situations, a first party's telephony device will use a first CODEC that communicates at a first bit rate, and the second party's telephony device will use a second CODEC that communicates at a second, higher bit rate. In these circumstances, one of the devices in communications path between the first and second telephony devices converts the lower bit rate data stream generated by the first CODEC on the first telephony device into a higher bit rate data stream that can be used by the second CODEC on the second telephony device. Likewise, the same device in the communications path converts the higher bit rate data stream generated by the second CODEC on the second telephony device into a lower bit rate stream that can be used by the first CODEC on the first telephony device. This type of a bit rate or CODEC conversion operation is commonly referred to as a transcoding operation. In this sort of a situation, although the second telephony device is using a higher bit rate than the first telephony device, the quality of the telephony communication is determined by the lower bit rate being used by the first telephony device.

Most systems and methods for setting the bit rate that is to be used for an IP telephony communication focus on the capabilities of the first and second party's telephony devices, and/or the present capability of the data communications channel between the first and second parties' telephony devices. The maximum possible bit rate of the telephony device with the lower capability is taken into account. Also the present capabilities of the data network communications channel is taken into account. The present capability of the data communications channel can be established by testing the speed and reliability of the communications channel with test data communications. Once these factors are determined, a bit rate is established for the telephony communication. Typically, based on the available bandwidth, the telephony devices for each party states its preferred CODEC and bit rate during call setup, and the two telephony devices then negotiate the CODEC to be used for the communication. The first and second parties' telephony devices are informed of that bit rate. The first and second parties' telephony devices then agree on a CODEC to be used for the telephony communication. As noted above, in some instances, the first and second telephony devices may end up using different CODECs that communicate at different bit rates, and an element in the communication path between the telephony devices may perform a transcoding operation. In yet other instances, where the first and second telephony devices are both capable of communicating with two or more CODECS, the first telephony device may send data using a first CODEC and the second telephony device may send data using a second CODEC, but no transcoding occurs at an interim element. Instead, because each telephony device is capable of receiving and using the CODEC being used by the other telephony device, it is possible for the telephony devices to use different CODECs.

Although known techniques for selecting a bit rate for IP telephony communications take into account the capabilities of the first and second telephony devices, and existing data network conditions, it would be desirable to take other factors into account in setting and controlling the bit rate that is used. For example, if one of the telephony devices that is to engage in an IP telephony communication is a mobile device that is communicating over a cellular telephony system, the user of the telephony device may have to pay a per/unit charge for data communications. For example, the user may have to pay a certain amount per megabyte or gigabyte of data. Similarly, the user may have a monthly allowance for data communications, and the user may have to pay extra for any data usage in excess of the monthly allowance. Under these circumstances, it would be desirable to take these factors into account when setting up an IP telephony communication for the user, so that the user can minimize the cost of conducting IP telephony communications.

In other instances, the data communications channel that is established between first and second telephony devices may have a data communications capability that varies over time. If that is the case, an IP telephony communication between the first and second telephony devices might begin at a point in time when the bit rate capability of the communications channel is high, and the bit rate capability of the communications channel might deteriorate as the IP telephony communication continues. If the first and second telephony devices attempt to continue the communication at a first, relatively high bit rate that is established at the beginning of the communication, the communication channel could deteriorate to the point where the communications channel can no longer support the initial bit rate. The result would increasingly poor communications quality, potentially leading to a dropped call.

Under these circumstances, where the communications channel established between first and second telephony devices is known to vary over time, it would be desirable to take the time varying nature of the communications channel into account when establishing the initial bit rate to be used for the communications channel. It may also be desirable to vary the bit rate, and thus the CODEC(s) that are used, as the telephony communication continues, to accommodate the known time varying nature of the communications channel. In instances where a CODEC capable of multiple bit rates is being used, the bit rate may change during a communication, while the CODEC remains the same.

### BRIEF DESCRIPTION OF THE DRAWINGS

FIG. 1 is a diagram of a communications environment including various elements which are associated with an Internet protocol (IP) telephony system operating in accordance with embodiments of the invention;

FIG. 2 is a diagram of various elements of a processor that forms part of an IP telephony system and/or part of a user's telephony device;

FIG. 3 is a diagram illustrating a communications environment in which systems and methods embodying the invention can be used;

FIG. 4 is a diagram illustrating elements of a data rate control unit for controlling a data rate of telephony communications;

FIG. 5 is a diagram of an IP telephony system embodying the claimed systems and methods;

FIG. 6 is a flow diagram illustrating a first method for controlling a data rate of IP telephony communications;

FIG. 7 is a flow diagram illustrating steps of a second method of controlling the data rate of IP telephony communications;

FIG. 8 is a flow diagram illustrating a third method of controlling a data rate of IP telephony communications;

FIG. 9 is a flow diagram illustrating a fourth method of controlling a data rate of IP telephony communications; and

FIG. 10 is a flow diagram illustrating a fifth method for controlling a data rate of IP telephony communications.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text or video communications using Internet protocol data communications.

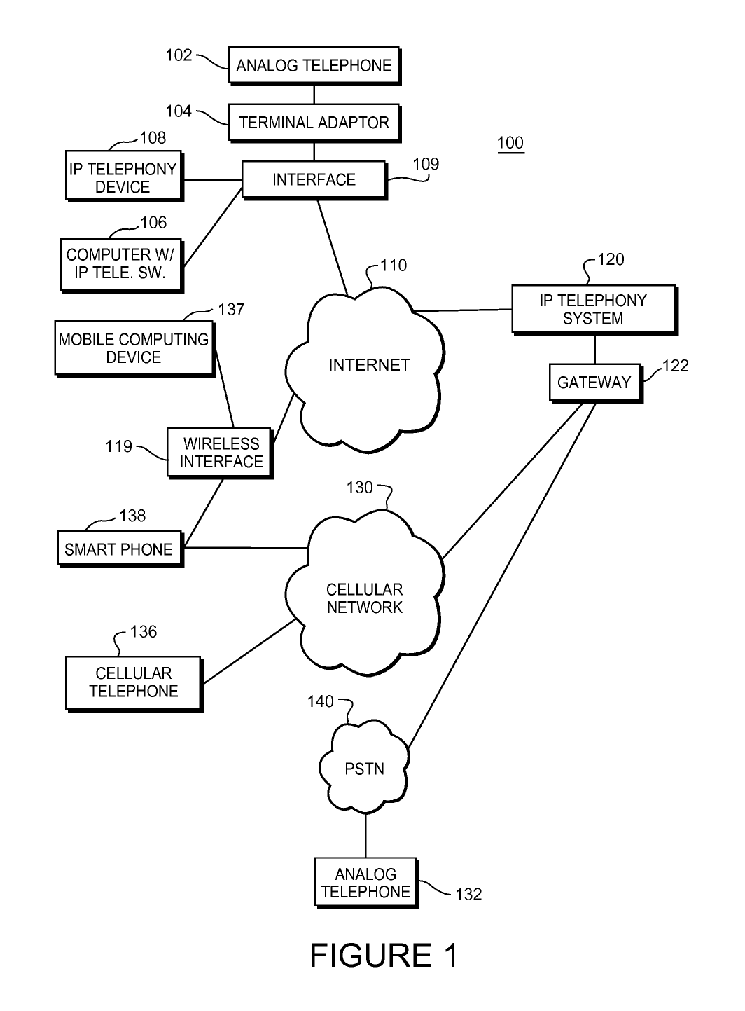

As illustrated in FIG. 1, a communications environment 100 is provided to facilitate IP based communications. An IP telephony system 120 enables connection of telephone calls between its own customers and other parties via data communications that pass over a data network. The IP telephony system 120 may also effect other forms of communications, such as video call, SMS/MMS messages, and other communications. The data network is commonly the Internet 110, however, private data networks may form all or a portion of the data communication path. The IP telephony system 120 is connected to the Internet 110. In addition, the IP telephony system 120 is connected to both a publicly switched telephone network (PSTN) 140 and a cellular telephony network 130 via one or more gateways 122.

The gateway 122 allows users and devices that are connected to the PSTN 140 and cellular network 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephony device 108 that is connected to the Internet 110 via an interface 109. Such an IP telephony device 108 could be connected to an Internet service provider via a wired connection or via a wireless router.

Alternatively, a customer could utilize a normal analog telephone 102 which is connected to the Internet 110 via a terminal adapter 104 and the interface 109. The terminal adapter 104 converts analog signals from the telephone 102 into digital data signals that pass over the Internet 110, and vice versa. Analog telephony devices include, but are not limited to, standard telephones and document imaging devices such as facsimile machines.

In addition, a customer could utilize a soft-phone client running on a computer 106 to place and receive IP based telephone calls, and to access other IP telephony systems (not shown). In some instances, the soft-phone client could be assigned its own telephone number. In other instances, the soft-phone client could be associated with a telephone number that is also assigned to an IP telephone 108, or to a terminal adaptor 104 that is connected to one or more analog telephones 102.

Likewise, a mobile computing device 137 may be used to send and receive telephony communications via the IP telephony system 120. The mobile computing device 137 could establish a data connection to the Internet 110 via a wireless interface 119, such as a WiFi router. IP telephony software on the mobile computing device 137 could then be used to conduct telephony communications through the IP telephony system 120.

A third party using an analog telephone 132 which is connected to the PSTN 140 may call a customer of the IP telephony system 120. In this instance, the call is initially connected from the analog telephone 132 to the PSTN 140, and then from the PSTN 140, through the gateway 122 to the IP telephony system 120. The IP telephony system 120 then routes the call to the customer's IP telephony device. Likewise, a third party using a cellular telephone 136 could also place a call to an IP telephony system customer, and the connection would be established in a similar manner, although the first link would involve communications between the cellular telephone 136 and a cellular telephony network 130.

In addition, a smartphone 138 that includes both mobile computing capabilities and cellular telephony capabilities can connect to the cellular network 130 using its cellular telephone capabilities. However, the smartphone 138 also may establish a data connection to the IP telephony system 120 via a wireless interface 119 and the Internet 110. In this instance, communications between the smartphone 138 and other parties could be entirely carried by data communications. Of course, alternate embodiments could utilize any other form of wired or wireless communications path to enable communications.

Users of the first IP telephony system 120 are able to access the service from virtually any location where they can connect to the Internet 110. Thus, a customer could register with an IP telephony system provider in the U.S., and that customer could then use an IP telephony device 108 located in a country outside the U.S. to access the services. Likewise, the customer could also utilize a computer with IP telephony software 106 or a mobile computing device with IP telephony software 137 outside the U.S. to access the IP telephony system 120. Further, in some instances a user could place a telephone call with the analog telephone 132 or the cellular telephone 136 that is routed through the PSTN 140 or cellular network 130, respectively, to the IP telephony system 120 via the gateway 122. This would typically be accomplished by the user calling a local telephone number that is routed to the IP telephony system 120 via the gateway 122. Once connected to the IP telephony system 120, the user may then place an outgoing long distance call to anywhere in the world using the IP telephony system's network. Thus, the user is able place a long distance call using lower cost IP telephony service provided by the IP telephony system 120, rather than a higher cost service provided by the PSTN 140 or cellular network 130.

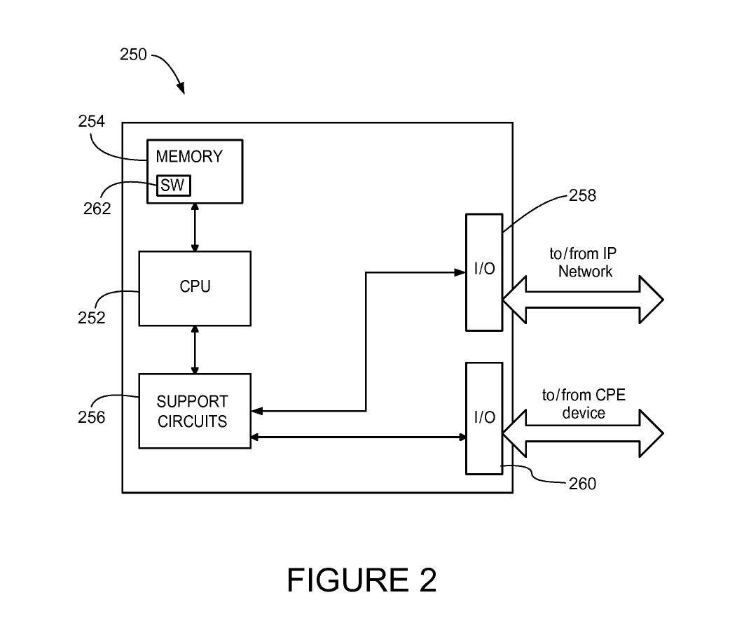

FIG. 2 illustrates elements of a computer processor 250 that can be used as part of the IP telephony system 120, part of a data rate control unit, or as part of a user's telephony device, to accomplish various functions. The IP telephony system 120 could include multiple processors 250 located at various locations in the system, along with their operating components and programming, each carrying out a specific or dedicated portion of the functions performed by the IP telephony system 120. Likewise, a user's telephony device could include one or more processors 250, along with their operating components and programming, each carrying out a specific or dedicated portion of the functions performed by the telephony device.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment, to service provider equipment, to and IP network or gateways, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 120, a data rate control unit 400, and/or a user's telephony device. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

In the following description, references will be made to an “IP telephony device.” This term is used to refer to any type of device which is capable of interacting with an IP telephony system to conduct or participate in an IP telephony communication. An IP telephony device could be an IP telephone, a computer running IP telephony software, a telephone adaptor which is connected to an analog telephone, or some other type of device capable of communicating via data packets. An IP telephony device could also be a cellular telephone, a smartphone, or a portable or tablet computing device that runs a software client that enables the device to act as an IP telephony device. Thus, a single device might be capable of operating as both a cellular telephone and an IP telephony device.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod touch™, which includes a speaker and a microphone. A software application loaded onto an Apple iPod touch™ can be run so that the Apple iPod touch can interact with an IP telephony system to conduct a telephone call. Similarly, an IP telephony software application could be run on a smart TV.

The following description will also refer to telephony communications and telephony activity. These terms are intended to encompass all types of telephony communications, regardless of whether all or a portion of the communications are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VOIP telephony system. In other words, these terms are intended to encompass any communications whatsoever, in any format, which traverse all or a portion of a communications network or telephony network.

In the following description, multiple different systems and methods for controlling the data rate of IP telephony communications are discussed. In some of these methods, historical data network conditions are used to set and selectively vary the data rate at which IP telephony communications are conducted. In other methods, a user's monthly data allowance with a cellular telephony system is taken into account in setting and adjusting the data rate at which that user conducts IP telephony communications. In some of the systems and methods disclosed below, the factors which are taken into account are used to constrain or reduce the data rate at which IP telephony communications are conducted. In other instances, such as where historical data network conditions are taken into account, the maximum allowable data rate is used, whenever possible, to ensure the highest quality communications.

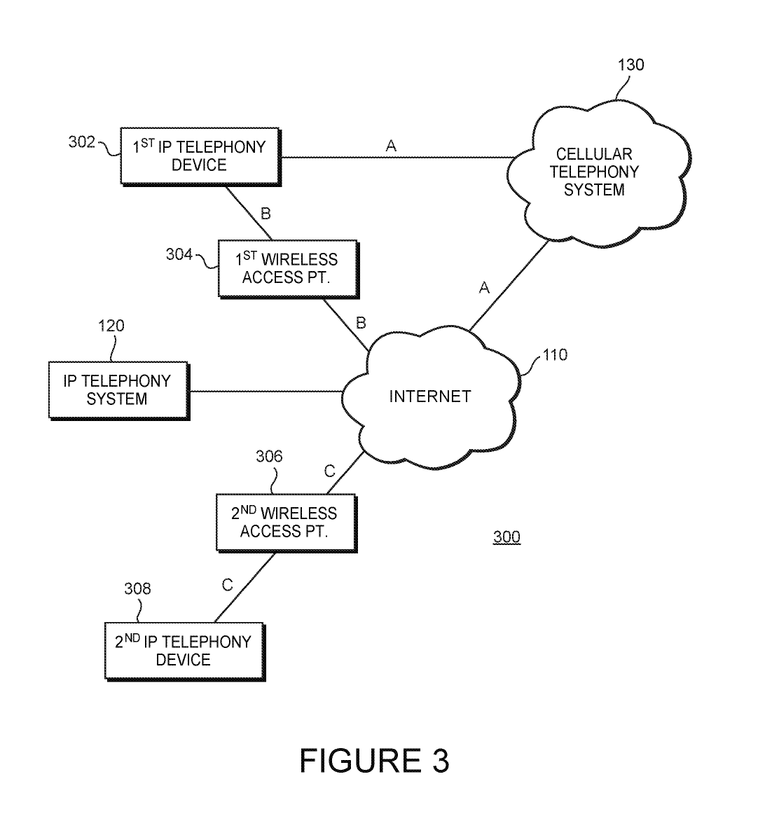

FIG. 3 illustrates a communications environment in which a first IP telephony device 302 is able to conduct an IP telephony communication with a second IP telephony device 308. As illustrated in FIG. 3, the first IP telephony device 302 can communicate with the second IP telephony device 308 via either a first communications channel A that passes through a cellular telephony system 130, or via a second communications channel B that passes through a first wireless access point 304. In either case, the first IP telephony device 302 will setup an IP telephony communication with the second IP telephony device 308 utilizing the services of an IP telephony system 120. Data packets bearing the media of the IP telephony communication pass through a data network, such as the Internet 110. In the communications environment illustrated in FIG. 3, the second IP telephony device 308 communicates through a third communications channel that passes through a second wireless access point 306, which provides access to the Internet 110. The communications environment illustrated in FIG. 3 will be used to describe various mechanisms for controlling the data rate at which the IP telephony communication is conducted, as is explained in detail below.

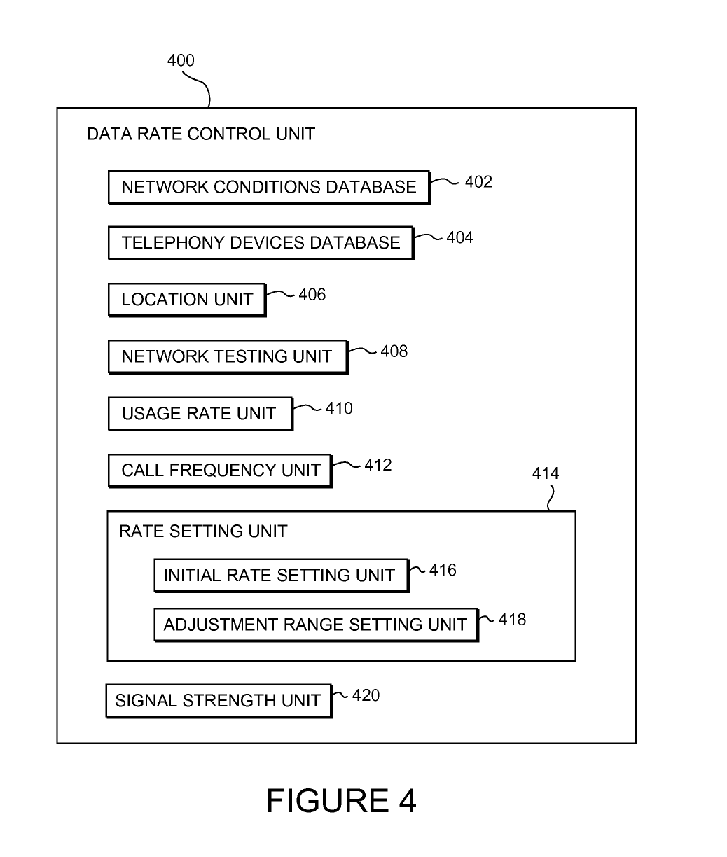

FIG. 4 illustrates selected elements of a data rate control unit 400. The data rate control unit 400 is used to set an initial data rate for IP telephony communications. In some instances, the data rate control unit 400 may also set a data rate adjustment range which includes an upper and a lower limit for the amount that the initial data rate can change as an IP telephony communication is ongoing. Elements of the data rate control unit 400 may also be used to determine how to selectively vary the data rate at which an IP telephony communication is conducted. A data rate control unit 400 as illustrated in FIG. 4 could be a part of an IP telephony system 120, or it could be resident on a user's telephony device.

The data rate control unit 400 includes a network conditions database 402, which stores historical information about the conditions that existed in the past in various portions of a data network that is used to conduct IP telephony communications. The information can includes the data rates at which reliable data communications were conducted at various different times in the past over various different portions of the data network. This can include the data rates at which reliable IP communications were conducted between two nodes in the Internet or a private data network. This can also include the data rates that were provided at various different times by individual cell towers of a cellular telephony service provider.

As is well known to those of ordinary skill in the art, the data rate at which data packet communications can be conducted across different portions of a data network can vary depending upon the location within the data network. In addition, the data rate at which reliable communications can be conducted through any given portion of a data network can vary depending upon the time of day, the day of the week, or even the week within a month. Information about the maximum reliable data rates of various different portions of a data network, and how those reliable data rates vary as function of time, are stored in the network conditions database 402.

For example, the network conditions database 402 could include information that indicates, for a specific cell tower (base station) of a cellular telephony service provider, the data rates at which the cell tower was capable of communicating with individual cellular telephones at various different times of the day, for various different days of the week, and for various different portions of a month. This same information can be tracked for multiple different cell towers. If this historical information is tracked over time for multiple months, the information can be used to predict the data rates at which an individual the cell tower is likely to be able to communicate at any given time of day and day of the week.

The data rate control unit 400 also includes a telephony devices database 404. The telephony devices database 404 can include various different items of information about individual user telephony devices. This can include information about calls or other telephony communications that have been conducted by various user telephony devices. This can also include information about the amount of data communicated by a user telephony device.

For example, if a given user's telephony device has a monthly data budget, information about that data budget, and information about how much of the data budget has been used in any given month, could also be stored in the telephony devices database 404. A monthly data budget refers to a data plan that the user may have with a telephony services provider, such as a cellular telephony services provider. It is common for a user to purchase a communications plan which allows the user to make use of up to a maximum amount of data in any given month without additional charges. However, if the user's data usage exceeds the monthly budget in any given month, the user will be charged additional amounts per unit of data used in excess of the monthly budget. Information about a particular telephony device's actual data usage over the course of a month could be periodically obtained from the cellular telephony service provider, and stored in the telephony devices database 404.

The data rate control unit 400 also includes a location unit 406, which determines the location at which a telephony device will initiate a new IP telephony communication. The location of a telephony device could be determined by GPS coordinate data reported from the telephony device, or possibly by the IP address being used by the telephony device. Information reported from a cellular telephony service provider might also be used to determine the location of a telephony device. The location unit 406 may also identify or determine the portion or portions of a data network which will be used to communicate with the user's telephony device once a new IP telephony communication begins. For example, if the user telephony device will communicate over a cell tower (base station) of a cellular telephony service provider, the location unit could identify the specific cellular tower that will be used. How this location unit 406 is then used to control the data rates for IP telephony communications is discussed in detail below.

The data rate control unit 400 also includes a network testing unit 408. The network testing unit 408 is used to test various portions of a data network to determine the maximum data rate at which reliable communications can be conducted. The network testing unit 408 could operate to send test data packets through a particular path through the data network in order to check data packet communication conditions. The testing would be done to determine various statistical measures of data packet communications which can be indicative of the quality of an IP telephony communication. Common examples are the data transfer rate, the frequency of dropped or lost data packets, latency, or the delay time for the delivery of packets, and jitter, which is a measure of the variable nature of the time taken to deliver data packets. Other data packet statistical measures could also be tested by the network testing unit 408.

The data rate control unit 400 further includes a usage rate unit 410. The usage rate unit 410 calculates the rate at which a user is using data under a monthly data budget. For example, the usage rate unit 410 could total the amount of data which has already been used by a user during the first 10 days of a month. The usage rate unit 410 could then calculate the average amount of data used per day. The average daily data usage rate could then be used to estimate the total amount of data that a user is likely to use during the month if the current usage rate continues to the end of the month.

The data rate control unit 400 further includes a call frequency unit 412. The call frequency unit 412 determines the typical number of calls made by a user on a daily basis. For example, if the user has made a total of fifty IP telephony communications during the first 10 days of a month, the call frequency unit 412 would calculate that the user is making IP telephony communications at a rate of approximately 5 per day. This information can then be used to help control or set the data rate at which future IP telephony communications are conducted. Note, the usage rate unit 410 and the call frequency unit 412 may both consult the telephony devices database 404 for data regarding an individual user's actual and/or typical usage patterns.

The data rate control unit 400 also includes a rate setting unit 414. The rate setting unit 414 includes an initial rate setting unit 416 and an adjustment range setting unit 418. The initial rate setting unit 416 uses various items of information to determine an initial data rate at which a user's IP telephony device will begin to conduct IP telephony communications. The adjustment range setting unit 418 determines a maximum allowable adjustment range for an IP telephony communication. This means how much the data rate can be adjusted upward or downward during the course of the IP telephony communication.

The data rate control unit can also include a signal strength unit 420. The signal strength unit 420 can determine the wireless signal strength that a user telephony device has when communicating with a cell tower or a wireless access point. This information could be determined or reported in various different ways. For example, and with reference to FIG. 3, the signal strength unit could report the signal strength of a signal received by the first IP telephony device 302 as it communicates with either a cell tower of the cellular telephony system 130 or the first wireless access point 304. Alternatively, the signal strength unit 420 could report the signal strength of a signal received by the first wireless access point 304 which was sent by the first IP telephony device 302. The signal strength unit 420 may also report a trend in a signal strength. In other words, the signal strength unit may report that the signal strength is gradually decreasing, or that the signal strength is gradually increasing—both indicative of the user's telephony device moving with respect to a fixed cell tower or wireless access point.

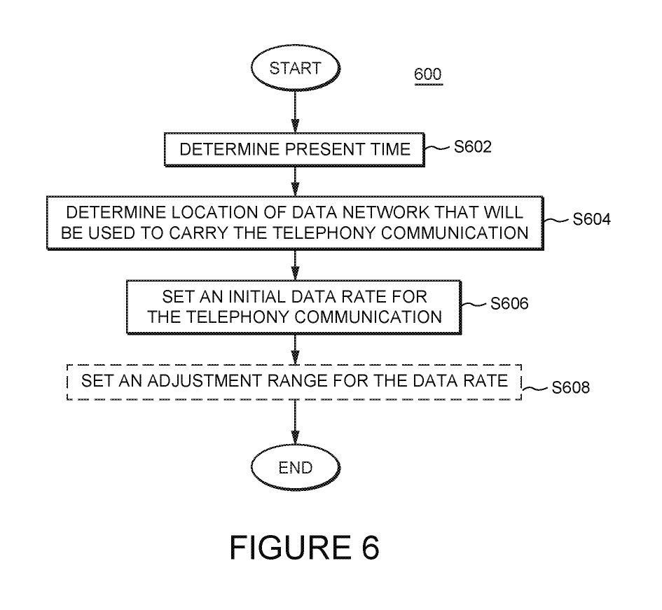

Although FIG. 4 illustrates selected elements of a data rate control unit 400, this depiction should in no way be considered limiting. Some data rate control units 400 may include a variety of other elements in addition to those illustrated in FIG. 4. Moreover, some embodiments of a data rate control unit 400 may not include all of the elements illustrated in FIG. 4. Detailed descriptions of how the data rate control unit 400 and its individual elements are used to set and control data rates or IP telephony communications are discussed in detail below. In conjunction with the various method flowcharts illustrated in FIGS. 6-10.

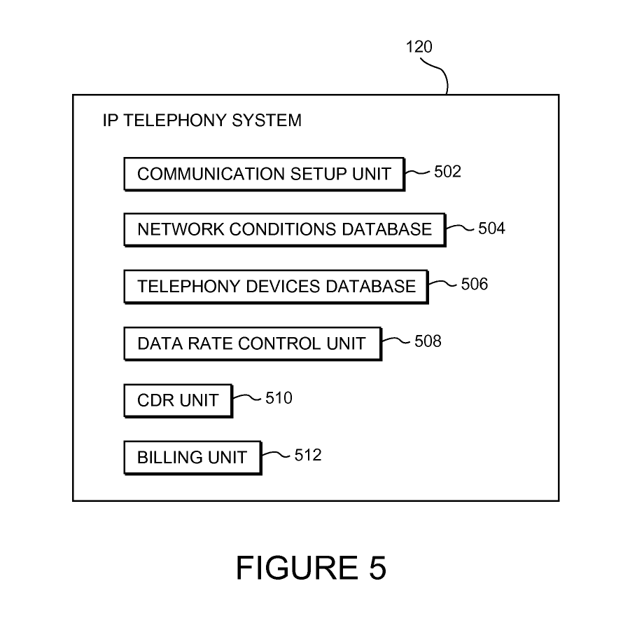

FIG. 5 illustrates selected elements of an IP telephony system 120 which is used to facilitate IP telephony communications. The IP telephony system 120 includes a communication setup unit 502, which facilitates the setup of new incoming IP telephony communications directed to the users of the IP telephony system 120. In addition, the communication setup unit 502 can assist one of the users of the IP telephony system 120 in setting up an outgoing telephony communication to another user of the system, or to a telephony device which is provided with its native telephony device by some other telephony system.

The IP telephony system 120 may optionally include a network conditions database 504 and a telephony devices database 506 that are similar to and that store the same types of information as the corresponding units discussed above in connection with the data rate control unit 400.

The IP telephony system 120 also includes a data rate control unit 508. The data rate control unit 508 is essentially the same as the data rate control unit 400 discussed above in connection with FIG. 4. However, the data rate control unit 508 in the IP telephony system 120 may not include the network conditions database and telephony devices database, which are shown as separate elements of the IP telephony system 120.

The IP telephony system also includes a call data record (CDR) unit. The CDR unit receives call data records which are generated by various elements of the communications environment and which include information about individual telephony communications handled by the IP telephony system 120. Those call data records are then stored in a database. In some instances, the CDR unit 510 may mediate information received from multiple elements of the communications environment, and then create one or more comprehensive call detail records relating to an IP telephony communication.

The IP telephony system 120 also includes a billing unit 512 which is responsible for generating bills or invoices for its own clients, and for other telephony systems which are terminating telephony communications through the IP telephony system 120. The billing unit 512 will make use of information stored in the call detail records created and stored by the CDR unit 510.

Although FIG. 5 illustrates selected elements of an IP telephony system, those of ordinary skill in the art will appreciate that a commercial IP telephony system will include a variety of other elements in addition to those illustrated in FIG. 5. Moreover, some embodiments of an IP telephony system 120 embodying the invention may not include all of the elements illustrated in FIG. 5.

FIG. 6 illustrates steps of a first method of controlling the data rate of IP telephony communications. The steps of the method illustrated in FIG. 6 would be performed by various elements of a data rate control unit 400, as illustrated in FIG. 4, and or by various elements of an IP telephony system 120 as illustrated in FIG. 5. In this method, historical data network conditions are taken into account in establishing an initial data rate for new IP telephony communications. This method would typically be performed when a new IP telephony communication is being setup for an IP telephony device. To facilitate the discussion of the method, references will also be made to the communications environment illustrated in FIG. 3.

Assuming that a first IP telephony device 302 would like to conduct an IP telephony communication with a second IP telephony device 308 as illustrated in FIG. 3. Assume also that the first IP telephony device 302 will communicate data through communications channel A, which makes use of a cell tower of the cellular telephony system 130. In this instance, the first IP telephony device 302 is initiating the IP telephony communication.

When the first IP telephony device 302 requests the setup of a new IP telephony communication with the second IP telephony device 308, elements of the IP telephony system 120, such as a communication setup unit 502, help to establish the IP telephony communication. A data rate control unit 400, which could be resident on the first IP telephony device 302, or the second IP telephony device 308, or the IP telephony system 120, performs the method illustrated in FIG. 6 to set an initial data rate for the IP telephony communication.

Turning to FIG. 6, the method 600 begins and proceeds to step S602 where the present time is determined. The present time could include the time of day, and also the day of the week or the week of the month. The method then proceeds to step S602 where a location unit 406 of a data rate control unit 400 determines a location of one or more portions of a data network that will communicate with the first IP telephony device 302. In this instance, and with reference to FIG. 3, the location unit 406 would determine that the first IP telephony device 302 will communicate with a specific cell tower of the cellular telephony system 130.

In some instances, the location unit may identify other portions of the data network that will be used to conduct the IP telephony communication. For example, the location unit may also identify portions of the data network corresponding to communications channel C, which passes from the Internet 110 through the second wireless access point 306 to the second IP telephony device 308.

Next, in step S606, an initial rate setting unit 416 of a rate setting unit 414 sets an initial data rate for the IP telephony communication. This initial data rate is set based upon information about historical data network conditions through the portions of the data network identified in step S604. The initial rate setting unit 416 makes use of the data stored in the network conditions database 402, which provides historical information about the typical or maximum data transfer rates which can be used to achieve reliable communications through those portions of the data network that are to be used, given the time of day determined in step S602. While historical data about data transfer conditions may not be a 100% accurate prediction for what will occur at the present time, the historical conditions will usually be relatively accurate in predicting how the data network will perform at the determined present time.

For example, the information in the network conditions database 402 may indicate that the portions of the data network provided along pathway A between the first IP telephony device 302 and the Internet 110 can provide a first relatively high data rate with good reliability. The network conditions database 402 may also indicate that pathway C between the second IP telephony device 308 and the Internet 110 only supports a second lower data rate with good reliability. Under those conditions, the initial rate setting unit 416 select the lower data rate for the IP telephony communication, in recognition of the fact that pathway C will likely only support this lower data rate.

The method may also include an optional step S608 where an adjustment range setting unit 418 sets an adjustment range for the data rate for the IP telephony communication. The adjustment range setting unit 418 could determine a maximum upper boundary for the data rate, and a minimum lower boundary for the data rate for the IP telephony communication. As the IP telephony communication continues, it may be possible to adjust the data rate upward or downward, depending upon actual network conditions, in order to ensure that the IP telephony communication proceeds with good or high quality.

As mentioned above in the Background section, various different CODECs can be used by the individual IP telephony devices to conduct the IP telephony communication. The data rate which is determined for the IP telephony communication can in turn determine the CODEC(s) that will be used for the IP telephony communication. In the case of a CODEC capable of multiple bit rates, the determined bit rate will set the bit rate at which the CODEC begins to operate. For example, if the initial rate setting unit 416 sets the initial data rate for an IP telephony communication between the first IP telephony device 302 and the second IP telephony device 308 to be a relatively low data rate, then both the first IP telephony device 302 and the second IP telephony device 308 can use a same or similar CODEC which operates at this relatively low data rate.

Once the initial data rate for the IP telephony communication has been determined, the method illustrated in FIG. 6 ends, and the IP telephony communication can begin between the first IP telephony device 302 and the second IP telephony device 308. In some instances, a network testing unit 408 could test network conditions along the data path extending between the first IP telephony device 302 and the second IP telephony device 308 to check the data transfer conditions which are occurring along this communications pathway. If the network testing unit 408 determines that a higher data rate can be used to reliably communicate data packets between the two IP telephony devices, the data rate being used for the IP telephony communication could be adjusted upward. Similarly, if the network testing unit 408 determines that the data communications cannot reliably proceed at the initial data rate, because the data packets are not being reliably communicated at that data rate, the data rate being used for the IP telephony communication could be adjusted downward.

In any event, by checking the historical network conditions prior to beginning a new IP telephony communication, one can help to set an initial data rate that is likely to be useful in conducting a reliable IP telephony communication with relatively high quality. Operating in this fashion also prevents a situation in which the IP telephony communication begins at a data rate which is too high to be supported by actual network conditions.

In addition, if the check of historical data network conditions which is performed in step S606 indicates that the network conditions will likely support a relatively high data rate at the present time, but that the data network conditions are likely to deteriorate over the next ten to twenty minutes, then the initial rate setting unit 416 may set the initial data rate for the IP telephony communication to a relatively low data rate. Although this would result in the IP telephony communication beginning at a lower data rate than actual network conditions currently will support, as time proceeds, and the IP telephony communication continues, and as the data network conditions begin to deteriorate, the lower initial data rate will not have to be changed as the IP telephony communication is ongoing. Thus, selecting a lower data rate at the beginning of the IP telephony communication obviates the need to change the data rate, and to switch to a different CODEC, in the middle of the IP telephony communication.

If the method also includes an optional step S608 of setting an adjustment range for the data rate, the historical network conditions can also be used to determine that adjustment range. For example, in the situation described above, where network conditions are likely to deteriorate during the course of an IP telephony communication, step S608 could involve setting an upper limit for the data rate which is no higher than the data rate which the network is likely to support over the course of the IP telephony communication.

In several of the examples described above, attempts are made to predict the network conditions which will occur as an IP telephony communication continues. The predicted network conditions are then used to set the initial data rate, and possibly also an adjustment range. In both instances, the likely length or duration of the IP telephony communication will affect the decision. If the IP telephony communication is likely to be relatively short, then it is less necessary to take probable future network conditions into account. If the IP telephony communication is likely to be quite lengthy, then future network conditions, as predicted from the historical database, can be quite helpful in setting the initial data rate and/or the adjustment range. For these reasons, a predicted length of an IP telephony communication may be taken into account in making these decisions.

For example, if the user of the first IP telephony device 302 typically engages in relatively short communications, this information can be used in making a decision about the initial data rate and/or the adjustment range. Conversely, if the user of the first IP telephony device 302 typically engages in quite lengthy communications, this information could also be taken into account. This type of historical information could be present in the telephony devices database 404, which tracks the telephony communications conducted by individual user telephony devices.

Another factor which may be taken into account in setting the initial data rate for a telephony communication is the signal strength of wireless data communications. For example, and with reference to FIG. 3, a signal strength unit 420 may provide information about the strength of a wireless data connection between the first IP telephony device 302 and a cell tower of the cellular telephony system 130. The signal strength unit 420 may also provide information about how the signal strength is presently changing. The wireless signal strength can be indicative of how well data communications are likely to proceed between these two devices. The initial rate setting unit 416 could take such signal strength information into account in setting the initial data rate for the IP telephony communication.

For example, if the first IP telephony device 302 is communicating with a cell tower of the cellular telephony system 130, and the signal strength is gradually increasing, then the initial rate setting unit 416 could select an initial rate which is supported by current network conditions, and set an adjustment range which allows for increasing the data rate. Conversely, if the signal strength information indicates the signal strength is gradually decreasing, then the initial data rate set for the IP telephony communication may be set to a rate which is lower than is currently supported by network conditions. As a result, if the signal strength continues to deteriorate, IP telephony communication can proceed at the lower data rate, even after the signal strength continues to deteriorate.

In the methods discussed above, historical data network conditions and information about the current data network conditions can both be taken into account in determining an initial data rate for an IP telephony communication, as well as an allowable adjustment range. In any given embodiment, only one piece of this information could be used, or multiple pieces of this information can be used together to set an initial data rate, or an adjustment range. Moreover, additional factors which are not discussed above could also be taken into account in determining the initial data rate, or an adjustment range.

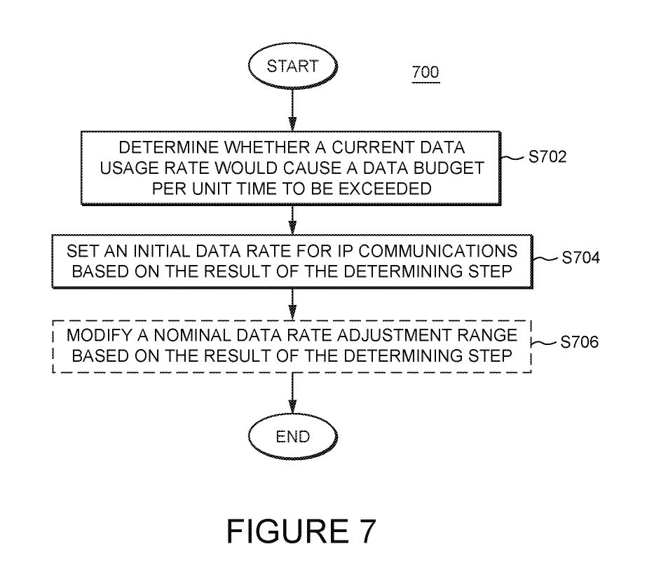

FIG. 7 illustrates steps of another method of controlling the data rate of an IP telephony communication. In this embodiment, information about a user's monthly data budget is taken into account in setting a data rate for IP telephony communications.

As mentioned above, if a user makes use of a cellular telephony system to conduct IP telephony communications, the data being transferred in order to conduct the IP telephony communication will count as part of the user's monthly data budget. For example, and with reference to FIG. 3, assume that the first IP telephony device 302 conducts an IP telephony communication with the second IP telephony device 308, and that the first IP telephony device 302 makes use of data pathway A, which traverses the cellular telephony system 130. The data packets used to conduct the IP telephony communication will count against the user's monthly data budget with the cellular telephony system 130.

For purposes of the following explanation, we will assume that the user of the first IP telephony device 302 can use up to a maximum of 4 gigabytes of data, with 1GB budgeted for voice communications, and the other 3GB dedicated to streaming video, data and other similar uses, in any given month as part of his monthly service charge. However, if the user exceeds the 4 gigabyte data budget in any given month, the user will pay additional amounts for each additional gigabyte of data used that month. Under these circumstances, it would be desirable for the user to ensure that his data usage in any given month does not exceed the 4 gigabyte monthly data budget. The method illustrated in FIG. 7 can be used to set the data rate at which IP telephony communications are conducted by the user of the first IP telephony device 302 to help to ensure that the user does not exceed his monthly data budget.

The method illustrated in FIG. 7 could be conducted periodically over the course of a month. Alternatively, the method illustrated in FIG. 7 could be conducted each day. Moreover, the method illustrated in FIG. 7 could be conducted each time that a user requests the setup of a new IP telephony communication. In any event, performance of the method illustrated in FIG. 7 is intended to set the initial data rate for IP telephony communications conducted by the first IP telephony device 302, in view of the user's monthly data budget and his present actual data usage, to try to avoid exceeding the monthly data budget.

In the descriptions which follow, they are references to a “nominal data rate.” A nominal data rate is a default data rate that will be used for IP telephony communications in the absence of other constraints. The nominal data rate would typically provide good quality for the IP telephony communication. However, it would be possible to conduct the IP telephony communications at lower data rates, and still maintain a reasonable level of quality.

The method 700 illustrated in FIG. 7 begins and proceeds to step S702 where a determination is made about whether the user's current average data usage rate, if continued to the end of the month, is likely to cause the user to exceed his monthly data budget. During this step, a usage rate unit 410 of the data rate control unit 400 illustrated in FIG. 4 determines the user's current average daily data usage rate. This average daily data usage rate would then be projected forward to the end of the current month to determine if the user is likely to exceed his monthly data budget.

To provide one concrete example, assume it is the 10th day of a 30-day month, and that the user has a monthly data budget of 1GB for voice communications. Assume also that the user is currently averaging 0.025 gigabytes of data usage per day while conducting IP telephony communications at the nominal data rate. Because it is the 10th day of the month, the user will have already used 0.25 gigabytes. Projecting this average daily usage rate forward to the end of the month, would predict that the user will use a total of 0.75 gigabytes of data, if he continues to conduct IP telephony communications at the same daily usage rate, using the nominal data rate. Because this would not cause the user to exceed his monthly data budget of 1GB, the user could continue to use the nominal data rate for the present time, without fear of exceeding his monthly data budget.

Alternatively, if the user has been averaging 0.05GB of data usage per day, and it is the 10th day of the month, the user will have already used 0.5GB of data by the 10th day of the month. Projecting this data usage rate forward to the end of the month, would predict that the user will make use of 1.5GB of data by the end of the month, far exceeding his monthly data budget of 1GB. Under those circumstances, it makes sense to lower the data rate for IP telephony communications going forward, in an attempt to prevent the user from exceeding his monthly data budget.

Returning to the method illustrated in FIG. 7, once the usage rate unit 410 determines whether the user's current data usage rate is likely to cause the user to exceed his monthly data budget, the method proceeds to step S704, and the initial rate setting unit 416 sets a data rate for future IP telephony communications during this month. As noted above, if the user is in no danger of exceeding his monthly data budget, the nominal data rate will be set in step S704. If the user is in danger of exceeding his monthly data budget, given his current average daily data usage, then in step S704, the initial rate setting unit 416 sets a lower than nominal data rate for future IP telephony communications. The degree to which user's data rate is lowered is based on how much the user is likely to exceed his monthly data budget if he were to continue consuming data at the present rate.

FIG. 7 also illustrates an optional additional step S706 in which a data rate adjustment range is also set for future IP telephony communications. The adjustment range can also be set based upon the information gathered in step S702, relating to whether or not the user is likely to exceed his monthly data budget. If the user is likely to exceed his data budget given current usage rates, then in step S706 the data rate parameters will be set so that the data rate cannot be adjusted upward. Alternatively, if the user is in no danger of exceeding his monthly data budget, then in step S706, an adjustment range for the data rate could be set so that the data rate can be increased during individual IP telephony communications in order to obtain higher quality.

Once an initial data rate is set, and perhaps an adjustment range, the method illustrated in FIG. 7 ends. The set data rates and adjustment ranges would then be used for future IP telephony communications during the remaining days of the month. The method illustrated in FIG. 7 could be re-performed on a daily basis to take into account recent usage patterns. Also, if a current month ends, and new month begins, the method illustrated in FIG. 7 could be re-performed to reset the initial data rate and data adjustment ranges, given that the user is now working against a new monthly data budget.

Another factor that may be taken into account in setting the initial data rate is the user's historical data usage patterns over previous months. For example, if a user frequently exceeds his monthly data budget, then the initial data rate might be lowered farther below the nominal data rate earlier in the month than would otherwise occur to help prevent the user from exceeding his data budget in the present month. Similarly, if an analysis of previous months indicates that the user tends to use a large amount of data during the last few days of each month, then the initial data rate set during days early in the present month may be set lower than would otherwise occur, in recognition of the fact that the user is likely to consume a large amount of data later in the month. Individual user usage patterns can thus be taken into account in setting the initial data rate for IP telephony communications, in addition to the other factors discussed above.

In the foregoing examples, a monthly data budget was contemplated. In other embodiments, a different total time period could be considered in performing similar methods. The selection of a month as the time period for a particular data budget is somewhat arbitrary, and only reflects the fact that current cellular data plans tend to use a one month time period for a data budget.

Information about a user's data usage could be drawn from a telephony services database 404, as illustrated for the data rate control unit 400 in FIG. 4. Alternatively, information about a user's actual data usage at any given point in time, or over a time period such as a month, could be drawn directly from the cellular telephony system which provides the user with his cellular service.

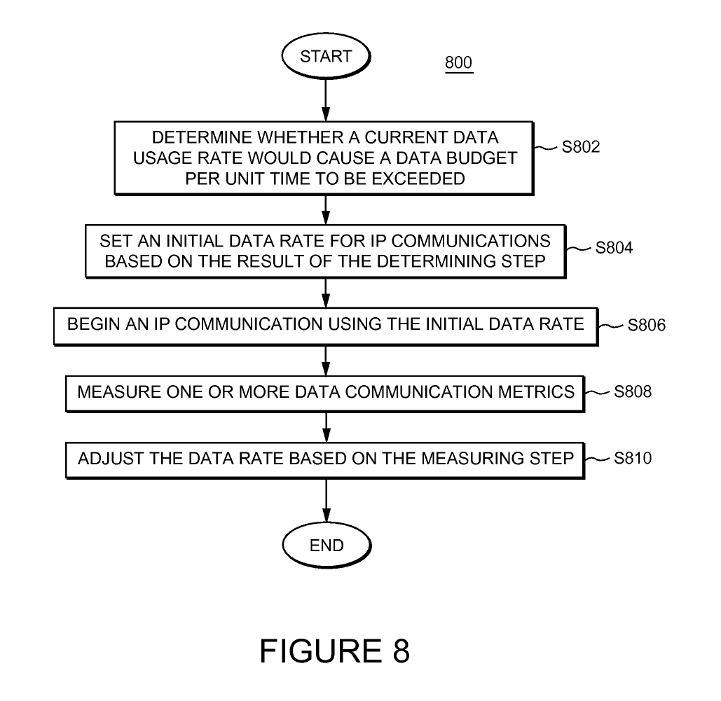

FIG. 8 illustrates an alternate method for controlling a data rate of an IP telephony communication which also takes into account the monthly data budget under which a user is operating. In this embodiment, however, the data rate could be adjusted during an IP telephony communication to account for current network conditions.

As illustrated in FIG. 8, the method 800 begins and proceeds to step S802 where a usage rate unit 410 determines whether a current data usage rate of a user is likely to cause a user to exceed his data budget. The method then proceeds to step S804 where an initial data rate is set for IP telephony communications based on the result of the determining step. Next, in step S806, an IP telephony communication begins using the initial data rate sent in step S804.

As the IP telephony communication continues, a network testing unit 408 tests actual network conditions while the IP telephony communication is ongoing. If the current network conditions would support a higher data rate, and the higher data rate is likely to result in a higher quality communication, then in step S810, the data rate for the IP telephony communication could be adjusted upward. Of course, this upward adjustment would only occur if doing so is not likely to cause the user to exceed his monthly data budget, given the information gathered in step S802.

Alternatively, the network conditions measured in step S808 could indicate that the data network is no longer capable of reliably communicating data packets at the initial data rate set in step S804. Under these conditions, the data rate could be adjusted downward to ensure that the IP telephony communication continues with relatively high quality. Although this would force the user's telephony devices to switch to a different CODEC, or to vary the bit rate being used by a CODEC capable of communicating at multiple bit rates, to utilizes a lower data rate, doing so could help to preserve the quality of the communication, as opposed to using a CODEC which requires a higher data rate which can no longer reliably be supported by the data network. Once the adjustment has been made in step S808, the method ends. In some embodiments, steps S808 and S810 may be re-performed on a periodic basis as an IP telephony communication continues to ensure that the IP telephony communication has an acceptable quality.

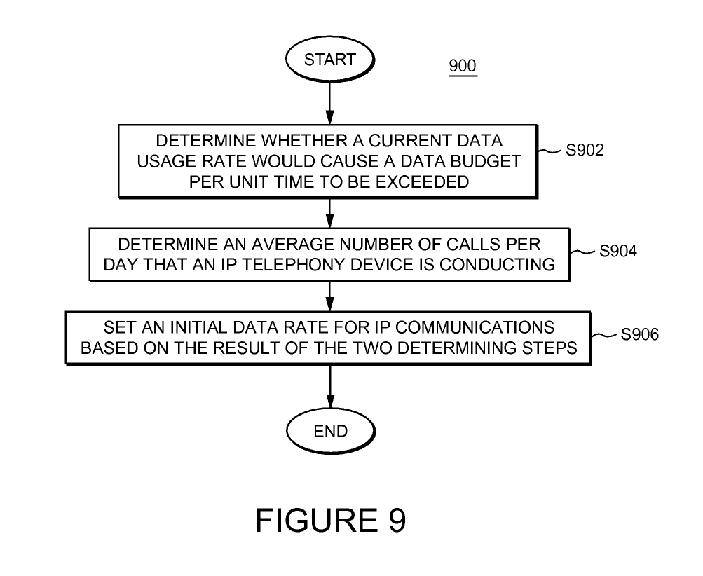

FIG. 9 illustrates another method embodying the invention which also takes into account a user's average data usage rate, the user's monthly data budget. The method 900 begins and proceeds to step S902 where a determination is made as to whether a current data usage rate would cause the user to exceed his monthly data budget. In step S904, a check is also performed to determine the average number of calls per day that the user is conducting. A call frequency unit 412, of a data rate control unit 400, could perform this step. Also, while FIG. 9 indicates that an average number of calls per day is determined by the call frequency unit 412, in alternate embodiments, the call frequency unit could determine an average number of call based on some other time period. For example, the call frequency unit 412 could determine the average number of calls per month that a user is making, or the average number of calls per week the user is making.

The method then proceeds to step S906 where an initial data rate for IP communications is set based on the information gathered in steps S902 and S904. The information gathered in step S902 is taken into account in the ways discussed above in connection with FIGS. 7 and 8. However, the information about the average number of calls that a user is making could also influence the initial data rate that is to be used for future IP telephony communications. For example, if the user is making a large number of average calls per unit of time, this could cause the usage rate unit 410 to set a data rate that is lower than the nominal rate for future IP telephony communications. This would be done in recognition of the fact that conducting a large number of calls on a frequent basis is likely to cause the user to exceed his monthly data budget, even if the information gathered is step S902 indicates that the user is not likely to exceed his monthly data budget. Alternatively, if the information gathered in step S904 indicates that the user is not making a large number of calls per unit of time, this information could be used to ensure that the initial data rate is set at the nominal data rate. Once the initial data rate is set in step S906, the method ends.

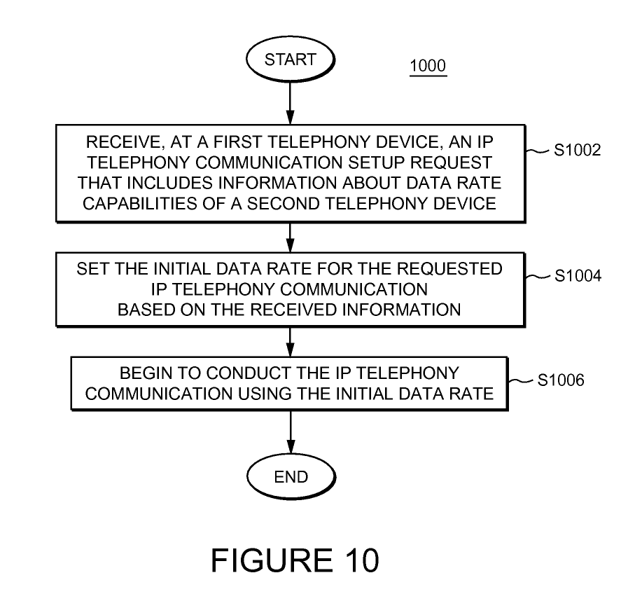

FIG. 10 illustrates another method for setting the initial data rate for an IP telephony communication. In this instance, the initial data rate is set based on information about the data rate that a second IP telephony device can use. For example, and with reference to FIG. 3, assume that the first IP telephony device 302 has requested the setup of a new IP telephony communication with the second IP telephony device 308.

As illustrated in FIG. 10, the method 1000 begins and proceeds to step S1002 where the second IP telephony device 308 receives a communication setup request which has been relayed from the first IP telephony device 302. Information about the data rate capabilities of the first IP telephony device 302 are included in the IP telephony communication setup request received by the second IP telephony device 308. For example, information about the data rate communication capabilities of the first IP telephony device 302, and/ information about a CODEC or CODECs that the first IP telephony device 302 can use, could be included in a header of a typical IP telephony communication setup request received by the second IP telephony device 308. The method then proceeds to step S1004 where the second IP telephony device 308 sets an initial data rate for the IP telephony communication based on the information it received about the capabilities of the first IP telephony device 302. The method then proceeds to step S1006 where the IP telephony communication begins. The method then ends.

A method as illustrated in FIG. 10 helps to prevent a situation in which one IP telephony device is conducting the IP telephony communication at a data rate that is greater than the data rate that can be used by the other IP telephony device involved in the IP telephony communication. For example, if the first IP telephony device 302 is communicating at a first relatively low data rate, and the second IP telephony device 308 is communicating at a second, relatively high data rate, then some element located between the two telephony devices must perform a transcoding operation so that the two devices can communicate with one another. For example, an element in the communication path could utilize the data packets being provided by the second IP telephony device to create a new stream of data packets having a lower data rate, and the lower data rate stream would then be provided to the first IP telephony device 302 which is only capable of communicating at that lower rate. Conversely, the same element would be utilizing a stream of data packets at a relatively low data rate provided by the first IP telephony device 302 to create a different, higher data rate stream which is then provided to the second IP telephony device 308 communicating at the higher data rate.

This situation basically wastes bandwidth, because it is unnecessary to communicate at the higher data rate. The quality of the IP telephony communication is determined by the lowest data rate in the communications channel. Thus, the second IP telephony device can be switched to a lower data rate which matches the data rate being used by the first IP telephony device without impairing or impacting the quality of the IP telephony communication. Doing so, in turn, reduces the bandwidth being used by the second IP telephony device, and it eliminates the need for any transcoding operation to be performed by an element located between the two IP telephony devices.

In most instances, when a new IP telephony communication is being setup, neither telephony device is aware of the data rate capabilities of the other IP telephony device. However, if this information is encoded in the typical IP communication setup messaging which passes between the two devices, then both devices can be made aware of the capabilities of the other device, and a suitable data rate can be selected for the IP telephony communication. As mentioned above, a convenient way of exchanging this information is to include the data rate information in a header of a typical IP telephony communication setup request.

In many of the foregoing descriptions, a software application running on a telephony device performs various functions. In alternate embodiments, a browser running on the telephony device may access a software application that is running on some other device via a data network connection. For example, the software application could be running on a remote server that is accessible via a data network connection. The software application running elsewhere, and accessible via a browser on the telephony device may provide all of the same functionality as an application running on the telephony device itself. Thus, any references in the foregoing description and the following claims to an application running on a telephony device are intended to also encompass embodiments and implementations where a browser running on a telephony device accesses a software application running elsewhere via a data network.

Also, although many of the examples provided about related to telephony communications, those telephony communications could be audio or video calls, or other forms of telephony communications. The methods and techniques described above could be used to enable many different types of communications. Thus, the foregoing references to calls or telephony communications should in no way be considered limiting.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of controlling the data rate of an Internet Protocol (IP) telephony communication that is to be conducted by an IP telephony device, comprising:
determining a time when a new IP telephony communication is being setup for an IP telephony device;
determining a location or an identity of a wireless network communications device through which the IP telephony device will communicate;
setting an initial data rate for the new IP telephony communication based on historical information that is indicative of a level of network activity typically handled by the wireless network communications device during the determined time.

2. The method of claim 1, wherein determining a time comprises determining a time of day and a day of the week.

3. The method of claim 1, further comprising setting a data rate adjustment range for the new IP telephony communication.

4. The method of claim 3, wherein the data rate adjustment range includes a maximum data rate and a minimum data rate for the new IP telephony communication.

5. The method of claim 3, wherein the data rate adjustment range is based on historical information that is indicative of a level of network activity typically handled by the wireless network communications device during the determined time.

6. The method of claim 1, further comprising:
commencing the IP telephony communication using the set initial data rate;
measuring one or more data communication metrics for data communications passing between the IP telephony device and the wireless network communications device as the IP telephony communication is ongoing; and
adjusting the data rate for the IP telephony communication based on the measurement results.

7. The method of claim 6, wherein measuring one or more data communication metrics comprises measuring one or more data communication metrics that can influence the quality of an IP telephony communication.

8. The method of claim 1, wherein setting the initial data rate for the new IP telephony communication also comprises setting the initial data rate based on a strength of a signal received by the IP telephony device from the wireless network communications device.

9. The method of claim 1, wherein setting the initial data rate for the new IP telephony communication also comprises setting the initial data rate based on a strength of a signal received by the wireless network communications device from the IP telephony device.

10. A system for controlling the data rate of an Internet Protocol (IP) telephony communication that is to be conducted by an IP telephony device, comprising:
means for determining time when a new IP telephony communication is being setup for an IP telephony device;
means for determining a location or an identity of a wireless network communications device through which the IP telephony device will communicate;
means for setting an initial data rate for the new IP telephony communication based on historical information that is indicative of a level of network activity typically handled by the wireless network communications device during the determined time.

11. A system for controlling the data rate of an Internet Protocol (IP) telephony communication that is to be conducted by an IP telephony device, comprising:
a data rate control unit that includes at least one processor, wherein the data rate control determines a time when a new IP telephony communication is being setup for an IP telephony device, and wherein the data rate control unit includes:
a location unit that determines a location or an identity of a wireless network communications device through which the IP telephony device will communicate; and
a rate setting unit that sets an initial data rate for the new IP telephony communication based on historical information that is indicative of a level of network activity typically handled by the wireless network communications device during the determined time.

12. The system of claim 11, wherein in determining a time, the data rate control unit determines a time of day and a day of the week.

13. The system of claim 11, wherein the rate setting unit comprises an adjustment range setting unit that sets a data rate adjustment range for the new IP telephony communication.

14. The system of claim 13, wherein the data rate adjustment range includes a maximum data rate and a minimum data rate for the new IP telephony communication.

15. The system of claim 13, wherein the adjustment range setting unit sets the data rate adjustment range based on historical information that is indicative of a level of network activity typically handled by the wireless network communications device during the determined time.

16. The system of claim 11, wherein the data rate control unit comprises a network testing unit that measures one or more data communication metrics for data communications passing between the IP telephony device and the wireless network communications device as the IP telephony communication is ongoing, and wherein the rate setting unit adjusts the data rate for the IP telephony communication based on the measurement results.

17. The system of claim 16, wherein the network testing unit measures one or more data communication metrics that can influence the quality of an IP telephony communication.

18. The system of claim 11, wherein the rate setting unit sets the initial data rate based on a strength of a signal received by the IP telephony device from the wireless network communications device.

19. The system of claim 1, wherein the rate setting unit sets the initial data rate for the new IP telephony communication based on a strength of a signal received by the wireless network communications device from the IP telephony device.
